(19) United States
(12) Patent Application Publication
(10) Pub. No.: US 2007/0251931 A1
(43) Pub. Date: Nov. 1, 2007

(54) Portable welder

(76) Inventors: Rod Lambirth, Kenna, NM (US); Brady Kane Adams, Pahrump, NV (US)

Correspondence Address: AMSTER, ROTHSTEIN & EBENSTEIN LLP, 90 PARK AVENUE, NEW YORK, NY, 10016, US

(21) Appl. No.: 11/728,696

(22) Filed: Mar. 26, 2007

Related U.S. Application Data
(60) Provisional application No. 60/796,835, filed on May 1, 2006.

(51) Int. Cl. B23K 9/10

(52) U.S. Cl. 219/130.1

(57) ABSTRACT

A portable welder including a housing, a power supply contained within the housing, a welding cable having a proximal end and a distal end, the proximal end of the welding cable being electrically connected to the power supply, a welding electrode that extends from the distal end of the welding cable, and a control system that adjusts welding current delivered to the welding electrode from the power supply based on user input.

### RELATED APPLICATIONS

This application claims priority to U.S. Provisional Patent Application Ser. No. 60/796,835, filed May 1, 2006.

### FIELD OF THE INVENTION

The present invention relates to welders, and in particular to self-contained portable welders having an internal power supply.

### BACKGROUND OF THE INVENTION

Arc welding is used to join two metal work pieces either by melting the metal work pieces directly or by melting a metal electrode between the metal work pieces using heat generated from an arc of high electricity formed between the work pieces and the metal electrode. The metal electrode is designed to conduct current generated by an arc welder to sustain the arc and to provide filler metal to form the weld.

There are numerous arc-welding devices known in the art, most of which include bulky and relatively heavy housing units that must be connected to a power source, such as a wall outlet or the battery of a vehicle. For example, U.S. Pat. No. 5,410,126 to Miller discloses a wire feed welder that is described as being “portable”. However, the welder of Miller requires an external source of power, which may either be utility power or a battery power source, such as a car battery. Thus, although the Miller welder can be relocated to and used at different work sites as long as an external power source is available, it is not portable in the sense that it does not allow the user to weld at various work sites without being tethered to a power source.

Accordingly, there is a need for a truly portable and self-contained welder that allows a user to relocate the welder from one work site to another without requiring an external power source to power the welder.

### SUMMARY OF THE INVENTION

A portable welder according to an exemplary embodiment of the present invention includes a housing, a power supply contained within the housing, and a welding cable having a proximal end and a distal end. The proximal end of the welding cable is electrically connected to the power supply. A welding electrode extends from the distal end of the welding cable. A control system adjusts welding current delivered to the welding electrode from the power supply based on user input.

In at least one embodiment, the power supply comprises at least one battery.

In at least one embodiment, the at least one battery is a Sealed-Lead Acid (SLA) battery.

In at least one embodiment, the at least one battery is an Absorbed Glass Matt (AGM)-type SLA battery.

In at least one embodiment, the portable welder further comprises a ground cable electrically connected to the at least one battery.

In at least one embodiment, the control system comprises a welding control electrical circuit.

In at least one embodiment, the welding control electrical circuit comprises a potentiometer that is adjusted by the user to control current delivered to the welding electrode from the power supply.

In at least one embodiment, the portable welder further comprises a wire feed motor that drives the welding electrode through the welding cable.

In at least one embodiment, the portable welder further comprises a welding gun disposed at the distal end of the welding cable.

In at least one embodiment, the wire feed motor is contained within the welding gun.

In at least one embodiment, the wire feed motor is contained within the housing.

In at least one embodiment, the welding electrode is a stick electrode.

In at least one embodiment, the housing comprises a handle for transporting the portable welder.

These and other features of this invention are described in, or are apparent from, the following detailed description of various exemplary embodiments of this invention.

### BRIEF DESCRIPTION OF THE DRAWINGS

Various exemplary embodiments of this invention will be described in detail, with reference to the following figures, wherein:

FIG. 1 is an elevation view of a portable welder according to an exemplary embodiment of the present invention;

FIG. 2 is a block diagram showing internal components of the portable welder of FIG. 1; and

FIG. 3 is a diagram showing a current control circuit used in the portable welder of FIG. 1.

### DETAILED DESCRIPTION OF PREFERRED EMBODIMENTS

Various exemplary embodiments of the present invention are directed to a portable welder that is lightweight enough for a user to easily transport the welder and perform welding jobs while still holding the welder either in hand or, for example, connected to a utility belt worn by the user. The welder according to the present invention is fully self-contained in that it includes an internal power supply which, in a preferred embodiment, includes one or more batteries. Thus, a user can simply remove the inventive portable welder from a storage shelf, charge the batteries in the welder, and walk to a work site with the welder to perform a welding operation.

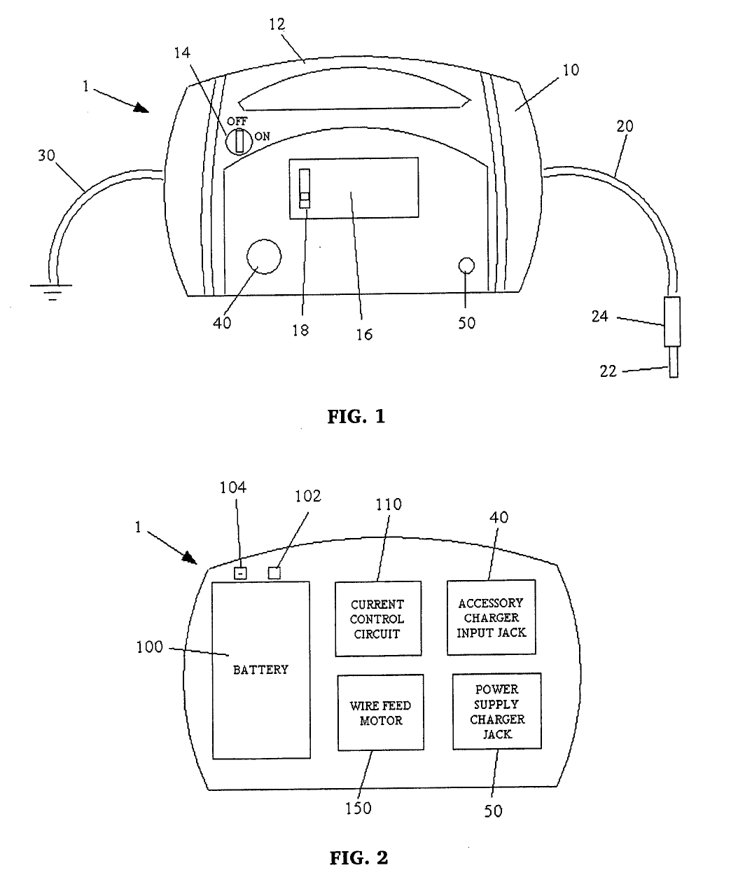

FIG. 1 is an elevation view of a portable welder, generally designated by reference number 1, according to an exemplary embodiment of the present invention. The portable welder 1 includes a housing 10 preferably made of a light-weight material, such as, for example, plastic. The housing 10 includes a handle portion 12 for ease of transport. The housing may also be equipped with attachments (not shown), such as hooks or straps, which allow the housing 10 to be hung from the user's utility belt or from an object nearby the work site while the portable welder 10 is in use.

The housing 10 includes a power on/off switch 14, and a control panel 16 that may include various other welding control switches and indicators. In a preferred embodiment, a current control switch 18 is provided in the control panel 16, the manipulation of which results in adjustment in the current delivered to a welding electrode, as discussed in further detail below.

A welding cable 20 extends from one side of the housing 10 and a ground cable 30 extends from the opposite side of the housing 10. A welding electrode 22 extends from a distal end of the welding cable 20. As is known in the art, current delivered to the electrode 22 creates an arc between the electrode 22 and a work piece, which in turn generates heat that melts the electrode onto the work piece.

The housing 10 may also include an accessory charger input jack 40 for insertion of an accessory, such as, for example, a flashlight, for charging from an internal power supply, as described in further detail below. In this regard, the housing 10 may include mounts (not shown) for storage of a variety of accessories. The housing 10 also includes a power supply charger jack 50 that receives a plug from a charger (not shown) to charge the internal power supply of the portable welder 1.

FIG. 2 is a block diagram showing the internal components of the portable welder 1. The portable welder 1 includes a battery 100 which supplies power to the portable welder 1. The battery is preferably a Sealed-Lead Acid (SLA) battery, which may either be an Absorbed Glass Mat (AGM) SLA battery or a Gel Cell SLA battery. However, an AGM-SLA battery is preferred for consistency in operation. Although only one battery 100 is shown in FIG. 2, it should be appreciated that any number and combination of different types of batteries may be used to provide the necessary welding power. The battery 100 includes a positive lead 102 and negative lead 104. The welding cable 20 is electrically connected to the positive lead 102, and the ground cable 30 is electrically connected to the negative lead 104. As is known in the art, connection of a welding cable to a positive lead of a battery results in higher temperature welds and therefore deeper penetration. Alternatively, the welding cable 20 may be electrically connected to the negative lead 104 and the ground cable 30 may be connected to the positive lead 102.

As the heat of the arc between the electrode 22 and a work piece depends on the current delivered to the electrode during the welding operation, it is important to maintain a constant current in the electrode, even as the voltage varies. Maintaining a stable welding temperature results in a more consistent weld. Thus, the portable welder 1 also includes a current control circuit 110 that maintains the current output from the battery 100 at a user-controlled level selected using the current control switch 18.

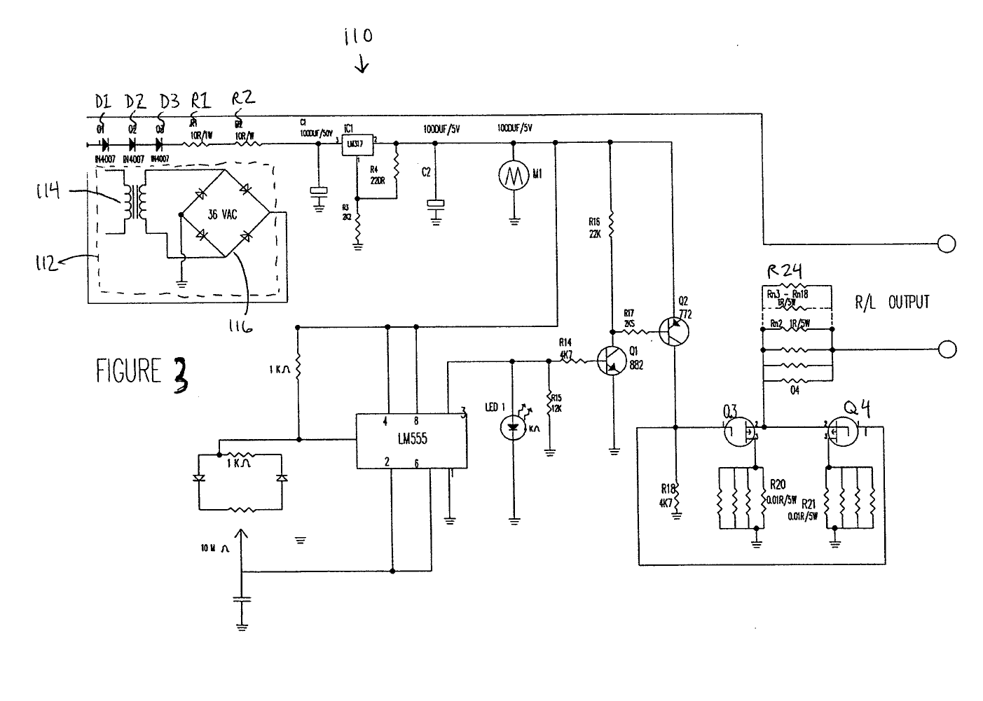

FIG. 3 is a diagram of the current control circuit 110 according to an exemplary embodiment of the present invention. The current control circuit 110 includes a charging circuit, generally designated by reference number 112. The charging circuit 112 includes a 115 VAC to 36 VAC step down transformer 114. A 4-diode bridge rectifier 116 converts the AC voltage output from the transformer 114 to DC voltage.

The current control circuit 110 further includes three diodes D1-D3 in series that reduce the DC voltage slightly. Two resistors R1 and R2 in conjunction with two capacitors C1 and C2 form a voltage filter for a line voltage regulator LM317 which outputs a constant voltage. An LM555 oscillator generates a variable duty-cycle square wave signal. The signal is biased to ground through the resistor R15 and boosted through transistors Q1 and Q2. The boosted signal is then used to drive two high current output drivers Q3 and Q4 to generate an R/L output. The R/L output is rapidly switched between being grounded and open for the length of time determined by a 10M OHM potentiometer in the LM555 oscillator, adjusted by the user through the current control switch 18. Driver resistor banks R20 and R21 on the output drivers Q3 and Q4 and output resistor bank R24 on the R/L output equalize the load on the two drivers Q3 and Q4 and reduce the maximum current draw.

The portable welder 1 may be a stick welder, in which case the welding electrode 22 is a stick electrode. Alternatively, the welding electrode 22 may be a wire electrode that extends through the welding cable 20. In the case of a wire electrode, the portable welder 1 may include a wire feed motor 150 that drives the wire electrode off of a spool as the electrode is consumed. The wire feed motor 150 may be disposed within the housing 10 or within a welding gun 24 disposed at the distal end portion of the welding cable 20.

While this invention has been described in conjunction with the exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A portable welder comprising:
a housing;
a power supply contained within the housing;
a welding cable having a proximal end and a distal end, the proximal end of the welding cable being electrically connected to the power supply;
a welding electrode that extends from the distal end of the welding cable; and
a control system that adjusts welding current delivered to the welding electrode from the power supply based on user input.

2. The portable welder of claim 1, wherein the power supply comprises at least one battery.

3. The portable welder of claim 2, wherein the at least one battery is a Sealed-Lead Acid (SLA) battery.

4. The portable welder of claim 3, wherein the at least one battery is an Absorbed Glass Matt (AGM)-type SLA battery.

5. The portable welder of claim 1, further comprising a ground cable electrically connected to the at least one battery.

6. The portable welder of claim 1, wherein the control system comprises a welding control electrical circuit.

7. The portable welder of claim 6, wherein the welding control electrical circuit comprises a potentiometer that is adjusted by the user to control current delivered to the welding electrode from the power supply.

8. The portable welder of claim 1, further comprising a wire feed motor that drives the welding electrode through the welding cable.

9. The portable welder of claim 8, further comprising a welding gun disposed at the distal end of the welding cable.

10. The portable welder of claim 9, wherein the wire feed motor is contained within the welding gun.

11. The portable welder of claim 8, wherein the wire feed motor is contained within the housing.

12. The portable welder of claim 1, wherein the welding electrode is a stick electrode.

13. The portable welder of claim 1, wherein the housing comprises a handle for transporting the portable welder.
